(19) United States
(12) Patent Application Publication
(10) Pub. No.: US 2017/0337810 A1
(43) Pub. Date: Nov. 23, 2017

(54) TRAFFIC CONDITION ESTIMATION APPARATUS, VEHICLE CONTROL SYSTEM, ROUTE GUIDANCE APPARATUS, TRAFFIC CONDITION ESTIMATION METHOD, AND TRAFFIC CONDITION ESTIMATION PROGRAM

(71) Applicant: HONDA MOTOR CO., LTD., Tokyo (JP)

(72) Inventors: Masaaki Abe, Wako-shi (JP); Masahiko Asakura, Wako-shi (JP); Naoto Sen, Wako-shi (JP)

(73) Assignee: HONDA MOTOR CO., LTD., Tokyo (JP)

(21) Appl. No.: 15/598,822

(22) Filed: May 18, 2017

(30) Foreign Application Priority Data
May 19, 2016 (JP) 2016-100850

(51) Int. Cl. G08G 1/01; G01C 21/34

(52) U.S. Cl. CPC G08G 1/0112; G01C 21/3415

(57) ABSTRACT

A traffic condition estimation apparatus includes: a collecting section configured to communicate with at least one vehicle and collect information concerning the position of the at least one vehicle and the destination set in the at least one vehicle; and an estimating section configured to estimate future traffic condition based on information collected by the collecting section.

### CROSS REFERENCES TO RELATED APPLICATIONS

The present application claims priority under 35U.S.C. §119 to Japanese Patent Application No. 2016-100850, filed May 19, 2016, entitled “Traffic Condition Estimation Apparatus, Vehicle Control System, Route Guidance Apparatus, Traffic Condition Estimation Method, and Traffic Condition Estimation Program.” The contents of this application are incorporated herein by reference in their entirety.

### TECHNICAL FIELD

The disclosure relates to a traffic condition estimation apparatus, a vehicle control system, a route guidance apparatus, a traffic condition estimation method, and a traffic condition estimation program.

### BACKGROUND

There are apparatuses which estimate traffic conditions using probe information which includes vehicle positions and the like and is transmitted from in-vehicle devices. There are also apparatuses which estimate traffic conditions of a target road link based on traffic conditions of a road link connected to the target road link (see Japanese Unexamined Patent Application Publication No. 2013-214232, for example).

### SUMMARY

Each of the aforementioned apparatuses predicts traffic conditions based on current position information of vehicles and cannot predict future traffic conditions in some cases.

The present application describes, for example, a traffic condition estimation apparatus, a vehicle control system, a route guidance apparatus, a traffic condition estimation method, and a traffic condition estimation program which are capable of estimating future traffic condition.

A first aspect of the present disclosure describes a traffic condition estimation apparatus including a collecting section configured to communicate with at least one vehicle and collect information concerning the position of the at least one vehicle and a destination set in the at least one vehicle, and an estimating section configured to estimate future traffic condition based on the information collected by the collecting section.

A second aspect of the present disclosure describes a traffic condition estimation apparatus including a collecting section configured to communicate with at least one vehicle and collect information concerning the position of the at least one vehicle and a travel route set in the at least one vehicle, and an estimating section configured to estimate future traffic condition based on the information collected by the collecting section.

In a third aspect of the present disclosure according to the first or second aspect, the estimating section may estimate time of passage at which each of the at least one vehicle which has provided the information collected by the collecting section is expected to pass each of at least one road segment.

In a fourth aspect of the present disclosure according to the third aspect, the collecting section may further collect auxiliary information used for the estimating section to estimate the time of passage.

In a fifth aspect of the present disclosure according to the fourth aspect, as the auxiliary information, the collecting section may collect average speed on road where the at least one vehicle which has provided the information collected by the collecting section is expected to travel by communicating with the at least one vehicle or a device other than the vehicle.

In a sixth aspect of the present disclosure according to the fourth aspect, from a vehicle performing automated drive, the collecting section may collect information concerning a plan of the automated drive as the auxiliary information.

In a seventh aspect of the present disclosure according to any one of the third to sixth aspects, the traffic condition estimation apparatus may further include a tally section configured to tally the number of vehicles which are expected to pass each of at least one road segment based in each time period based on the time of passage estimated by the estimating section.

In a eighth aspect of the present disclosure according to the seventh aspect, the traffic condition estimation apparatus may further include a traffic congestion information generating section configured to generate information concerning the presence or degree of traffic congestion for each of the at least one road segment, based on the number of vehicles tallied by the tally section.

In a ninth aspect of the present disclosure according to any one of the first to eighth aspects, the traffic condition estimation apparatus may further include a route generating section configured to generate a recommended route for the at least one vehicle based on the future traffic condition estimated by the estimating section.

A tenth aspect of the present disclosure describes a vehicle control system including an automated driving controller configured to execute automated drive that automatically performs at least one of vehicle speed control and steering control. Here, the automated driving controller determines a plan of the automated drive by reflecting the result of estimation by the traffic condition estimation apparatus according to any one of the first to ninth aspects.

A eleventh aspect of the present disclosure describes a route guiding apparatus configured to perform vehicle route guidance based on the result of estimation by the traffic condition estimation apparatus according to any one of the first to ninth aspects.

A twelfth aspect of the present disclosure describes a traffic condition estimating method executed by an in-vehicle computer, the method including communicating with at least one vehicle to collect information concerning the position of the at least one vehicle and a destination set in the at least one vehicle, and estimating future traffic condition based on the collected information.

A thirteenth aspect of the present disclosure describes a traffic condition estimating program causing an in-vehicle computer to execute processes to communicate with at least one vehicle to collect information concerning the position of the at least one vehicle and a destination set in the at least one vehicle, and estimate future traffic condition based on the collected information.

According to the first, second, third, seventh, twelfth, or thirteenth aspect, for example, the estimating section estimates the future traffic condition based on the collected information.

According to the fourth, fifth, or sixth aspect, for example, the estimating section collects the average speed on the road where the vehicle is scheduled to travel or the information concerning automated drive as the auxiliary information and estimate the future traffic condition based on the collected information with a higher degree of accuracy.

According to the eighth aspect, for example, the traffic congestion information generating section generates the information concerning the presence or degree of traffic congestion based on the future traffic condition, thus providing information concerning traffic congestion.

According to the ninth aspect, for example, the route generating section generates a recommended route based on the future traffic condition and provides the generated recommended route.

According to the tenth aspect, for example, the automated drive section of the vehicle control system controls the vehicle according to an automated driving plan which reflects the estimated future traffic condition. Accordingly, the automated drive section organizes a plan to control the vehicle in accordance with the future traffic condition, so as to avoid traffic congestion or select the shortest route.

According to the eleventh aspect, for example, the route guidance apparatus guides the vehicle based on the future estimation result. Accordingly, the route guidance apparatus creates a route more preferable for the vehicle's occupant.

### BRIEF DESCRIPTION OF THE DRAWINGS The advantages of the disclosure will become apparent in the following description taken in conjunction with the following drawings.

FIG. 1 is a view illustrating constituent components of a system-mounted vehicle of one embodiment.

FIG. 2 is a functional block diagram of a vehicle control system and devices therearound.

FIG. 3 is a block diagram of an HMI.

FIG. 4 is a view illustrating the way the relative position of the vehicle to a travel lane is recognized by a vehicle position recognizing section.

FIG. 5 is a view illustrating an example of an action plan generated for a certain section.

FIG. 6 is a diagram illustrating an example of the configuration of a trajectory generating section.

FIG. 7 is a view illustrating an example of trajectory candidates generated by a trajectory candidate generating section.

FIG. 8 is a view illustrating trajectory candidates generated by the trajectory candidate generating section with trajectory points.

FIG. 9 is a view illustrating a lane change target position.

FIG. 10 is a diagram illustrating a speed generation model when it is assumed that three surrounding vehicles are moving at constant speed.

FIG. 11 is a table illustrating an example of mode-based restriction information.

FIG. 12 is a view illustrating an example of the configuration of a traffic condition estimation system.

FIG. 13 is a table illustrating an example of corrected information.

FIG. 14 is a table illustrating an example of estimated information.

FIG. 15 is a table illustrating an example of tally information.

FIG. 16 is a flowchart illustrating a flow of the process which is executed by a traffic condition estimation apparatus.

FIG. 17 is a diagram illustrating examples of routes calculated by an estimating section.

FIGS. 18A and 18B are diagrams illustrating the degree of future traffic congestion in a monitor area which is changed by the process of FIG. 17.

FIG. 19 is a flowchart illustrating a flow of the process executed by a vehicle and the traffic condition estimation apparatus.

FIG. 20 is a diagram illustrating an example of the shortest route calculated by the traffic condition estimation apparatus.

FIG. 21 is a diagram illustrating an example of an interface image displayed on a display apparatus of the vehicle.

FIG. 22 is a table illustrating an example of corrected information of Modification 1 of embodiment.

FIG. 23 is a table illustrating an example of corrected information of Modification 2 of embodiment.

FIG. 24 is a table illustrating an example of tally information of a tally section of Modification 2.

### DETAILED DESCRIPTION

Hereinafter, a description is given of embodiments of a traffic condition estimation apparatus, a vehicle control system, a route guidance apparatus, a traffic condition estimation method, and a traffic condition estimation program of the disclosure with reference to the drawings.

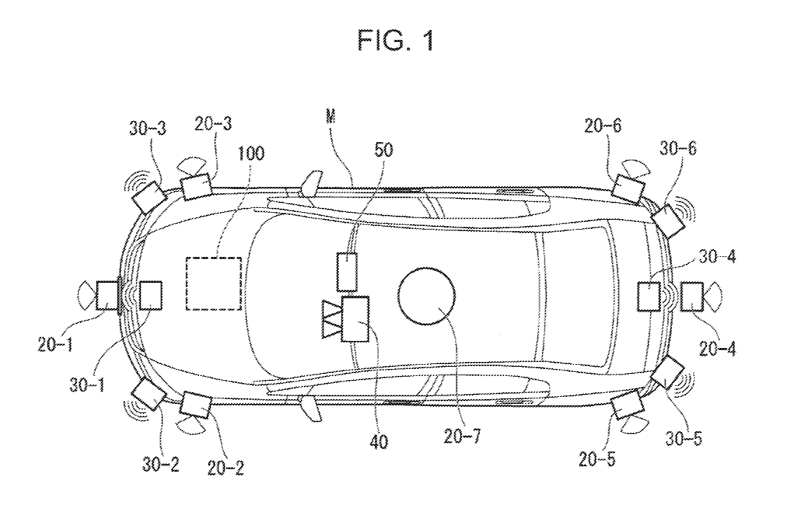

FIG. 1 is a view illustrating constituent components of a vehicle on which a vehicle control system 100 of each embodiment is mounted (hereinafter, referred to as a vehicle M). Examples of the vehicle on which the vehicle control system 100 is mounted are two-wheel, three-wheel, and four wheel automobiles, including automobiles powered by an internal combustion engine, such as a diesel or gasoline engine, electric vehicles powered by an electric motor, and hybrid vehicles including both an internal combustion engine and an electric motor. Electric vehicles are driven using electric power discharged from batteries such as secondary batteries, hydrogen fuel cells, metal fuel cells, and alcohol fuel cells, for example.

As illustrated in FIG. 1, the vehicle M is provided with sensors, including finders 20-1 to 20-7, radars 30-1 to 30-6, and a camera 40, a navigation device (a route guidance apparatus) 50, and the vehicle control system 100.

The finders 20-1 to 20-7 are LIDARs (light detection and ranging or laser imaging detection and ranging) which measure the distance to an object by measuring scattering light with respect to projected light, for example. For example, the finder 20-1 is attached to the front grill or the like, and the finders 20-2 and 20-3 are attached to side surfaces of the vehicle body, to door mirrors, within headlights, near side marker lamps, or the like. The finder 20-4 is attached to a trunk lid or the like, and the finders 20-5 and 20-6 are attached to side surfaces of the vehicle body, inside the tail lamp, or the like. Each of the aforementioned finders 20-1 to 20-6 has a detection range of about 150 degrees in the horizontal direction, for example. The finder 20-7 is attached to a roof or the like. The detection range of the finder 20-7 is 360 degrees in the horizontal direction, for example.

The radars 30-1 and 30-4 are long-distance millimeter-wave radars having a wider detection range in depth than the other radars, for example. The radars 30-2, 30-3, 30-5, and 30-6 are middle distance millimeter-wave radars having a narrower detection range in the depth than the radars 30-1 and 30-4.

The finders 20-1 to 20-7 are referred to just as finders 20 below if not distinguished in particular, and the radars 30-1 to 30-6 are referred to just as radars 30 if not distinguished in particular. The radars 30 detect an object using a frequency modulated continuous wave (FM-CW) method, for example.

The camera 40 is a digital camera including a solid state image sensor such as a charge coupled device (CCD) or a complementary metal oxide semiconductor (CMOS), for example. The camera 40 is attached to upper part of the front windshield, the back of the rear-view mirror, or the like. The camera 40 is configured to repeatedly capture an image of the front view from the vehicle M periodically. The camera 40 may be a stereo camera including plural cameras.

The configuration illustrated in FIG. 1 is just an example and may be partially omitted. The configuration of the vehicle M may additionally include another configuration.

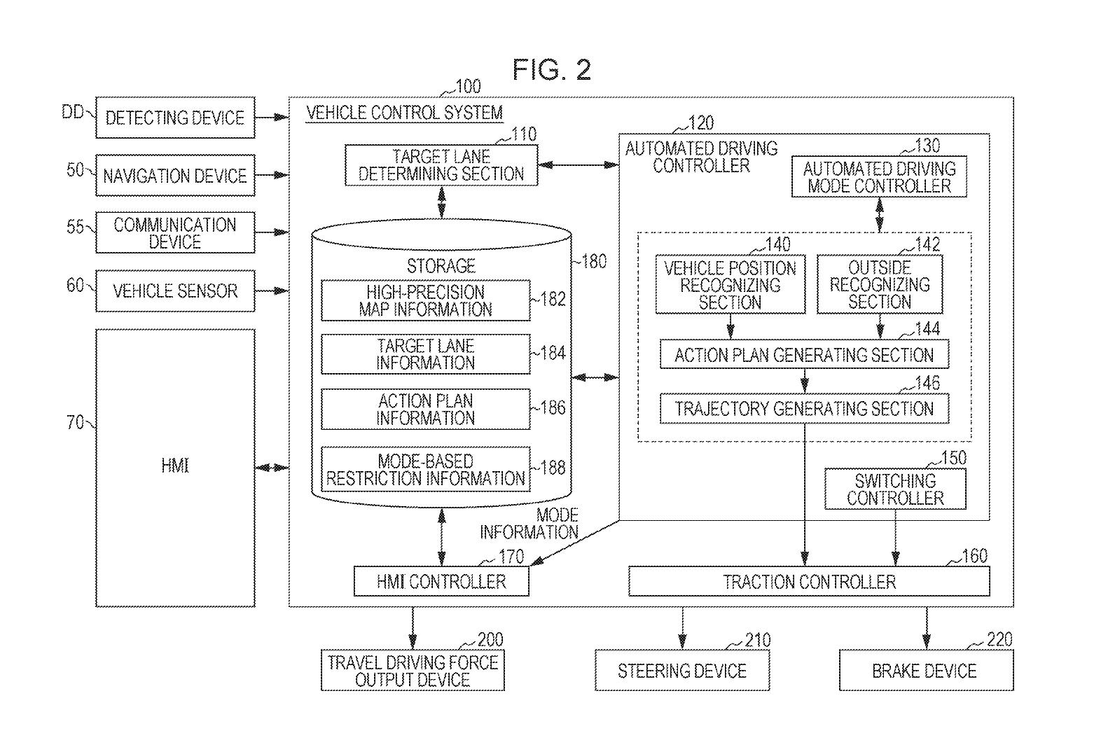

FIG. 2 is a functional block diagram of the vehicle control system 100 according to the embodiment and other devices therearound. The vehicle M is equipped with a detection device DD including the finders 20, radars 30, and camera 40, the navigation device 50, a communication device 55, a vehicle sensor 60, a human machine interface (HMI) 70, the vehicle control system 100, a travel driving force output device 200, a steering device 210, and a brake device 220. These devices and equipment are connected to each other via a multiple communication line such as a controller area network (CAN), a serial communication line, a wireless communication network, or the like. The vehicle control system of the disclosure does not indicate only the vehicle control system 100 and may include the configurations (the detection device DD, HMI 70, or the like) other than the vehicle control system 100.

The navigation device 50 includes a global navigation satellite system (GNSS) receiver, map information (a navigation map), a touch panel display device serving as a user interface, a speaker, a microphone, and the like. The navigation device 50 specifies the position of the vehicle M through the GNSS receiver and calculates the route from the specified position to the destination specified by the user. The route calculated by the navigation device 50 is provided to a target lane determining section 110 of the vehicle control system 100. The position of the vehicle M may be specified or complemented by an inertial navigation system (INS) using the output from the vehicle sensor 60. The navigation device 50 provides voice guidance or navigating display of the route to the destination while the vehicle control system 100 is executing a manual driving mode. The configuration to specify the position of the vehicle M may be provided independently of the navigation device 50. The navigation device 50 may be implemented by the function of a user's terminal device such as a smartphone or a tablet terminal, for example. In this case, the terminal device and vehicle control system 100 exchange information through wireless or wired communication.

The navigation device 50 acquires processing results of the later-described traffic condition estimation apparatus 300 and performs route guidance for the vehicle M based on the acquired information. The navigation device 50 calculates the shortest route to the destination, a route avoiding congested segments, and the like, for example, and guides the vehicle M so that the vehicle M travels along the calculated route. The processing results of the traffic condition estimation apparatus 300 include the number of vehicles passing through each road during each time period, the degree of traffic congestion, and the like. The traffic condition estimation apparatuses 300 are described in detail later.

The function of calculating a route may be provided for the traffic condition estimation apparatus 300 instead of the navigation device 50. In this case, the navigation device 50 transmits the destination set by the vehicle occupant to the traffic condition estimation apparatus 300 and acquires the route to the destination calculated by the traffic condition estimation apparatus 300. The navigation device 50 guides the vehicle M so that the vehicle M travels along the route calculated by the traffic condition estimation apparatus 300.

The communication device 55 performs wireless communication using a cellular network, a Wi-Fi network, Bluetooth (registered trademark), dedicated short range communication (DSRC), or the like, for example.

The vehicle sensor 60 includes a vehicle speed sensor detecting vehicle speed, an acceleration sensor detecting acceleration, a yaw-rate sensor detecting angular speed around the vertical direction, a direction sensor detecting the orientation of the vehicle M, and the like.

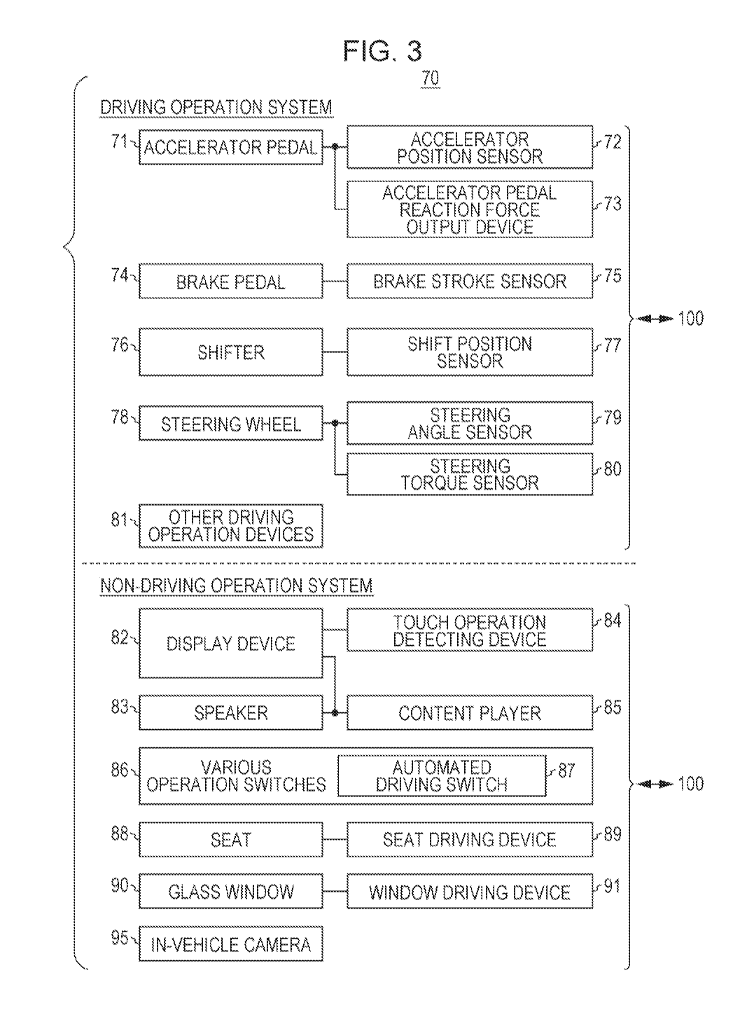

FIG. 3 is a block diagram of the HMI 70. The HMI 70 includes driving operation systems and non-driving operation systems, for example. These are not clearly separated. The driving operation systems may include a non-driving operation function (and vice versa).

The driving operation systems of the HMI 70 include an accelerator pedal 71, an accelerator position sensor 72, an accelerator pedal reaction force output device 73, a brake pedal 74, a brake pedal stroke sensor (or a master pressure sensor) 75, a shifter 76, a shift position sensor 77, a steering wheel 78, a steering angle sensor 79, a steering torque sensor 80, and another driving operation device 81.

The accelerator pedal 71 is an operator configured to accept an instruction from a vehicle occupant to accelerate the vehicle (or an instruction to decelerate the vehicle by a return operation). The accelerator position sensor 72 detects the amount of stroke of the accelerator pedal 71 and outputs an accelerator position signal representing the amount of stroke to the vehicle control system 100. The accelerator position sensor 72 may be configured to directly output the accelerator position signal to the travel driving force output device 200, steering device 210, or brake device 220 instead of the vehicle control system 100. The same goes for the other driving operation systems described below. The accelerator pedal reaction force output device 73 outputs force to the accelerator pedal 71 in the opposite direction to the direction of operation in response to an instruction from the vehicle control system 100, for example.

The brake pedal 74 is an operator configured to accept an instruction from the vehicle occupant to decelerate the vehicle. The brake stroke sensor 75 detects the amount of stroke (or depression force) of the brake pedal 74 and outputs a brake signal representing the result of detection to the vehicle control system 100.

The shifter 76 is an operator configured to accept an instruction from the vehicle occupant to change the shift position. The shift position sensor 77 detects the shift position specified by the vehicle occupant and outputs a shift position signal representing the result of detection to the vehicle control system 100.

The steering wheel 78 is an operator configured to accept an instruction from the vehicle occupant to turn the vehicle M. The steering angle sensor 79 detects the operation angle of the steering wheel 78 and outputs a steering angle signal representing the result of detection to the vehicle control system 100. The steering torque sensor 80 detects torque applied to the steering wheel 78 and outputs a steering torque signal representing the result of detection to the vehicle control system 100.

The other driving operation devices 81 include a joy stick, a button, a dial switch, and a graphical user interface (GUI) switch, for example. The other driving operation devices 81 accept instructions to accelerate, decelerate, or turn the vehicle and output the same to the vehicle control system 100.

The non-driving operation systems of the HMI 70 include a display device 82, a speaker 83, a touch operation detection device 84, a content player 85, various operation switches 86, a seat 88, a seat driving device 89, a glass window 90, a window driving device 91, and an in-vehicle camera 95, for example.

The display device 82 is a liquid crystal display (LCD) or an organic electroluminescence (EL) display device and is attached to any section of the instrument panel or a proper place facing the front, passenger's seat or a rear seat, for example. The display device 82 may be a head up display (HUD) projecting an image onto the front windshield or another window. The speaker 83 outputs audio. The touch operation detection device 84 detects the touch position in the display screen of the display device 82 and outputs the detected position to the vehicle control system 100 when the display device 82 is a touch panel. When the display device 82 is not a touch panel, the touch operation detection device 84 may be omitted.

The content player 85 includes a digital versatile disc (DVD) player, a compact disc (CD) player, a television receiver, or a device to generate various types of guidance images, for example. Each of the display device 82, speaker 83, touch operation detection device 84, and content player 85 may be partially or entirely shared with the navigation device 50.

The various operation switches 86 are provided at proper places in the compartment. The various operation switches 86 include an automated driving switch 87 which instructs to start (or to start in future) and stop automated drive. The automated driving switch 87 may be either a graphical user interface (GUI) switch or a mechanical switch. The various operation switches 86 may include switches to drive the seat driving device 89 and window driving device 91.

The seat 88 is a seat at which the vehicle occupant is seated. The seat driving device 89 freely drives the reclining angle, the position in the longitudinal direction, the yaw angle, and the like of the seat 88. The glass window 90 is provided for each door, for example. The window driving device 91 opens and closes the glass window 90.

The in-vehicle camera 95 is a digital camera using a solid-state imaging device such as a CCD or CMOS. The in-vehicle camera 95 is attached to such a position that the in-vehicle camera 95 takes an image of at least the head of the vehicle occupant performing driving operations, such as the rearview mirror, steering boss, or instrument panel. The camera 40 takes an image of the vehicle occupant periodically and repeatedly, for example.

Prior to the description of the vehicle control system 100, the travel driving force output device 200, steering device 210, and brake device 220 are described.

The travel driving force output device 200 outputs to driving wheels, travel driving force (torque) allowing the vehicle to travel. The travel driving force output device 200 includes an engine, a transmission, and an engine electronic control unit (ECU) controlling the engine when the vehicle M is an automobile powered by an internal combustion engine, for example. The travel driving force output device 200 includes a travel motor and a motor ECU controlling the travel motor when the vehicle M is an electric vehicle powered by an electric motor. The travel driving force output device 200 includes an engine, a transmission, an engine ECU, a travel motor, and a motor ECU when the vehicle M is a hybrid vehicle. When the travel driving force output device 200 includes only the engine, the engine ECU adjusts the throttle opening of the engine, the shift position, and the like in accordance with information inputted from a later-described travel controller 160. When the travel driving force output device 200 includes only the travel motor, the motor ECU adjusts the duty ratio of PWM signal given to the travel motor in accordance with the information inputted from the travel controller 160. When the travel driving force output device 200 includes both the engine and travel motor, the engine ECU and motor ECU control the travel driving force in cooperation in accordance with the information inputted from the travel controller 160.

The steering device 210 includes a steering ECU and an electric motor, for example. The electric motor applies force to a rack and pinion mechanism to change the direction of steered wheels, for example. The steering ECU drives the electric motor in accordance with information inputted from the vehicle control system 100 or information on the inputted steering angle or steering torque to change the direction of the steered wheels.

The brake device 220 is an electric servo-brake device including a brake caliper, a cylinder transmitting hydraulic pressure to the brake caliper, an electric motor generating hydraulic pressure in the cylinder, and a braking controller. The braking controller of the electric servo brake device controls the electric motor in accordance with information inputted from the travel controller 160 so that each wheel is supplied with brake torque in response to the braking operation. As a backup, the electric motor servo brake device may include a mechanism which transmits hydraulic pressure generated by operation of the brake pedal to the cylinder through a master cylinder. The brake device 220 is not limited to the above-described electric servo brake device and may be an electronically-controlled hydraulic brake device. The electronically-controlled hydraulic brake device controls an actuator in accordance with information inputted from the travel controller 160 to transmit the hydraulic pressure of the master cylinder to the cylinder. The brake device 220 may include a regenerative brake by the travel motor which can be included in the travel driving force output device 200.

### [Vehicle Control System]

The vehicle control system 100 is described below. The vehicle control system 100 is implemented by one or more processors or hardware having functions equivalent thereto, for example. The vehicle control system 100 may be a combination of electronic control units (ECUs) including a processor such as a central processing unit (CPU), a storage device, and a communication interface connected through an internal bus, micro-processing units (MPUs), or the like.

Back to FIG. 2, the vehicle control system 100 includes the target lane determining section 110, automated driving controller 120, travel controller 160, and storage 180, for example. The automated driving controller 120 includes an automated driving mode controller 130, a vehicle position recognizing section 140, an outside recognizing section 142, an action plan generating section 144, a trajectory generating section 146, and a switching controller 150, for example. Some or all of the target lane determining section 110, each section of the automated driving controller 120, and travel controller 160 are implemented by a processor executing a program (software). Alternatively, some or all of the same may be implemented by hardware such as large scale integration (LSI) or application specific integrated circuit (ASIC) or may be implemented by a combination of software and hardware.

The storage 180 stores information including high-precision map information 182, target lane information 184, action plan information 186, and mode-based restriction information 188, for example. The storage 180 is implemented by a read only memory (ROM), a random access memory (RAM), a hard disk drive (HDD), a flash memory, and the like. The program executed by the processor may be stored in the storage 180 in advance or may be downloaded from an external device through in-vehicle Internet equipment or the like. The program may be installed in the storage 180 by inserting a portable storage medium storing the program into a not-illustrated drive device. The vehicle control system 100 may be distributed to plural computer devices.

The target lane determining section 110 is implemented by a MPU, for example. The target lane determining section 110 divides the route provided from the navigation device 50 into plural blocks and determines the target lane for each block with reference to the high-precision map information 182. The target lane determining section 110 divides the route every 100 m in the vehicle travel direction, for example. For example, the target lane determining section 110 determines that the vehicle is to travel the “X-th” lane from the left. When the route includes a diverging place, for example. The target lane determining section 110 determines the target lane so that the vehicle M travel in a reasonable lane for accessing the diverging road. The target lane determined by the target lane determining section 110 is stored in the storage 180 as the target lane information 184.

The high-precision map information 182 is map information more precise than the navigation map of the navigation device 50. The high-precision map information 182 includes information on the center of each lane or boundaries thereof, for example. The high-precision map information 182 may include road information, traffic control information, address information (addresses and zip codes), facility information, telephone number information, and the like. The road information may include information representing road types such as freeway, toll road, national highway, and prefectural road, the number of lanes of each road, the width of each lane, the road gradient, the position of each road (three-dimensional coordinates including the longitude, latitude, and altitude), the curvature of each curve, positions of merging and diverging points in each lane, and road signs. The traffic control information includes information on lanes blocked due to construction, traffic accidents, traffic congestion, and the like.

The automated driving mode controller 130 determines the mode of automated drive carried out by the automated driving controller 120. The mode of automated drive in the embodiment includes the following modes. The following modes are shown just by way of example, and the number of modes of automated drive may be determined properly.

[Mode A] Mode A is a mode in which the automated drive degree is the highest. When Mode A is in execution, every vehicle control, including complicated merge control, is automatically conducted, and it is unnecessary for the vehicle occupant to keep watch on the circumstance around the vehicle M and the state of the vehicle M.

[Mode B] Mode B is a mode in which the automated drive degree is the next highest to Mode A. When Mode B is in execution, every vehicle control is automatically conducted in principle, but the driving operation of the vehicle M is handed over to the vehicle occupant in some situations. It is therefore necessary for the vehicle occupant to keep watch on the circumstances around the vehicle M and the state of the vehicle M.

[Mode C] Mode C is a mode in which the automated drive degree is the next highest to Mode B. When Mode C is in execution, the vehicle occupant needs to perform confirmation operation for the HMI 70 in accordance with the situation. In Mode C, automatic lane change is conducted when the vehicle occupant is notified of the time to change lanes and performs operation to change lanes for the HMI 70, for example. It is therefore necessary for the vehicle occupant to keep watch on the circumstances around the vehicle M and the state of the vehicle M.

The automated driving mode controller 130 determines the mode of automated drive based on an operation by the vehicle occupant for the EMI 70, an event determined by the action plan generating section 144, the traveling style determined by the trajectory generating section 146, and the like. The mode of automated drive is provided to the HMI controller 170. There may be limitations set on the modes of automated drive depending on the capabilities of the detection device DD of the vehicle M or the like. When the detection device DD has low capabilities, Mode A is not executed, for example. Any mode of automated drive can be switched to a manual driving mode through an operation for a driving operation system in the HMI 70 (override).

The vehicle position recognizing section 140 of the automated driving controller 120 recognizes the lane where the vehicle M is traveling (traveling lane) and the relative position of the vehicle M to the travel lane based on the high-precision map information 182 stored in the storage 180 and information inputted from the finders 20, radars 30, camera 40, navigation device 50, or vehicle sensor 60.

The vehicle position recognizing section 140 recognizes the travel lane by comparing the pattern of road lines recognized from the high-precision map information 182 with the pattern of road lines around the vehicle M recognized from the image taken by the camera 40. The recognition may be performed considering the position of the vehicle M acquired from the navigation device 50 and the results of processing by INS.

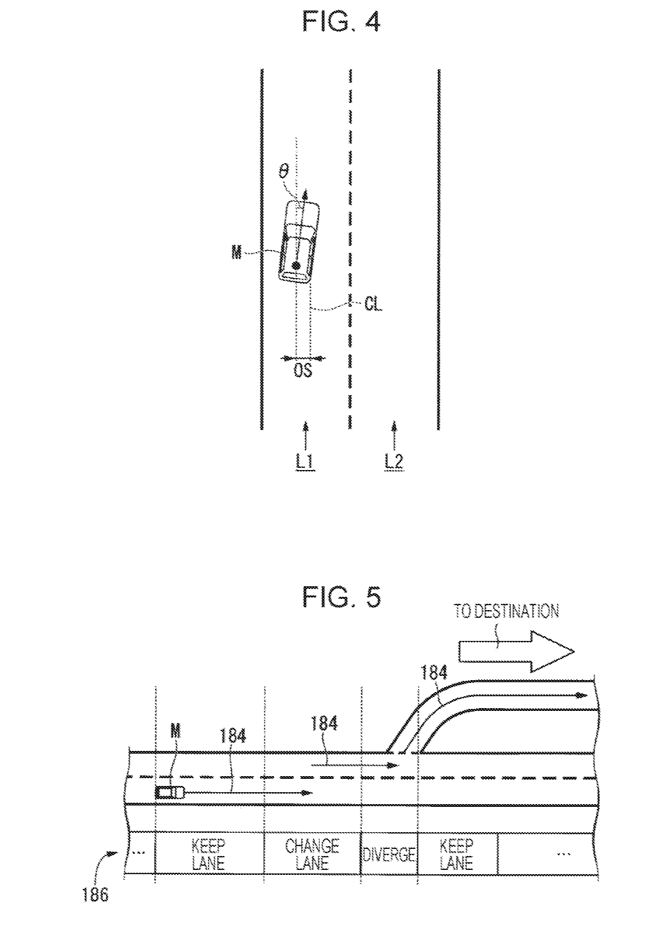

FIG. 4 is a diagram illustrating how the relative position of the vehicle M to a travel lane L1 is recognized by the vehicle position recognizing section 140. As the relative position of the vehicle M to the travel lane L1, the vehicle position recognizing section 140 recognizes a deviation OS of the reference point (the center of gravity, for example) of the vehicle from the center CL of the travel lane L1 and an angle θ between the direction of travel of the vehicle M and the center CL of the travel lane L1. Instead of the aforementioned recognition, the vehicle position recognizing section 140 may recognize the position of the reference point of the vehicle M relative to any side edge of the travel lane L1 as the relative position of the vehicle M to the travel lane L1. The relative position of the vehicle M recognized by the vehicle position recognizing section 140 is provided to the target lane determining section 110.

The outside recognizing section 142 recognizes the positions of surrounding vehicles and conditions of the surrounding vehicles such as speed and acceleration based on information inputted from the finders 20, radars 30, camera 40, and the like. The surrounding vehicles refer to vehicles which are traveling around the vehicle M in the same direction as the vehicle M, for example. The position of each surrounding vehicle is represented by a representative point thereof, such as the center of gravity or corners of the vehicle or may be represented by a region expressed in the vehicle's outline. The conditions of each surrounding vehicle may include information on the acceleration of the same and whether the vehicle of interest is changing lanes or is going to change lanes. Such information is known based on the information from the above described various devices. In addition to the surrounding vehicles, the outside recognizing section 142 may recognize the positions of guardrails, telephone poles, parked vehicles, pedestrians, and other objects.

The action plan generating section 144 sets the starting point of automated drive and/or the destination of the same. The starting point of automated drive may be the current position of the vehicle M or the position where the operation to start automated drive is performed. The action plan generating section 144 generates an action plan for a section between the starting point and destination of automated drive. Alternatively, the action plan generating section 144 may generate an action plan for an arbitrary section.

The action plan is composed of plural events which are executed sequentially, for example. The events include: a deceleration event that decelerates the vehicle M; an acceleration event that accelerates the vehicle M; a lane keeping event that causes the vehicle M to travel in the current travel lane; a lane changing event that causes the vehicle M to change lanes; an overtaking event that causes the vehicle M to overtake the vehicle traveling ahead; a diverging event that causes the vehicle M to move to a desired lane at a diverging point or keeps the vehicle M traveling in the current travel lane; a merging event that causes the vehicle M to accelerate or decelerate in a merging lane, which merges into a main lane, to move to the main lane; and a handover event that changes the driving mode from the manual driving mode to the automated driving mode at the starting point of automated drive and from the automated driving mode to the manual driving mode at the scheduled end point of automated drive. The action plan generating section 144 sets a lane changing event, a diverging event, or a merging event at a place where the target lane determined by the target lane determining section 110 is changed. The information indicating the action plan generated by the action plan generating section 144 is stored in the storage 180 as the action plan information 186.

FIG. 5 is a diagram illustrating an example of action plans generated for a certain section. As illustrated in FIG. 5, the action plan generating section 144 generates an action plan necessary for the vehicle M to travel through the target lane indicated by the target lane information 184. The action plan generating section 144 may dynamically change the action plan independently of the target lane information 184 as the situations of the vehicle M changes. For example, the action plan generating section 144 changes the event set for a section where the vehicle M is scheduled to travel when the speed of one of the surrounding vehicles recognized by the outside recognizing section 142 exceeds a threshold value while the vehicle M is traveling or when a surrounding vehicle traveling in the lane next to the travel lane of the vehicle M moves toward the travel lane of the vehicle M. In an action plan configured so that the lane changing event is executed after the lane keeping event, for example, when the recognition result of the outside recognizing section 142 reveals that a vehicle is travelling from behind at a speed higher than the threshold value in the lane to which the vehicle is scheduled to move, the action plan generating section 144 may change the event subsequent to the lane keeping event from the lane changing event to the deceleration event, lane keeping event, or the like. The vehicle control system 100 therefore allows the vehicle M to implement automated travel safely even when the external situation has changed.

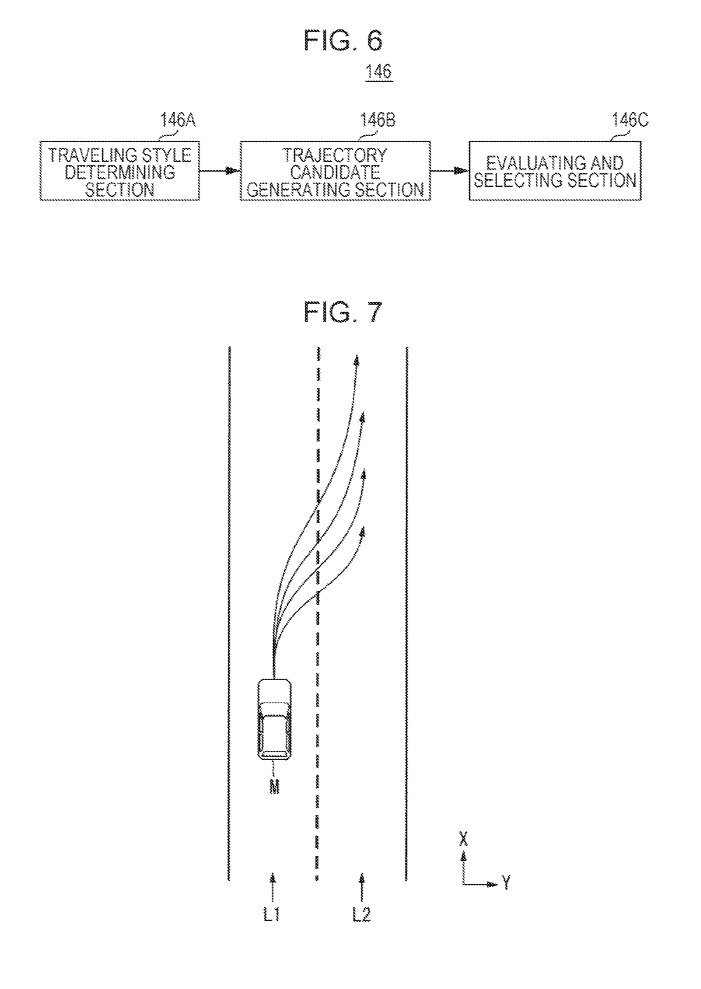

FIG. 6 is a diagram illustrating an example of the configuration of the trajectory generating section 146. The trajectory generating section 146 includes a travelling style determining section 146A, a trajectory candidate generating section 146B, and an evaluation and selection section 146C, for example.

At executing a lane keep event, for example, the travelling style determining section 146A determines the travelling style to be any one of constant speed travel, following travel, slow following travel, deceleration travel, curve travel, obstacle avoiding travel and the like. When there are no other vehicles in front of the vehicle M, the travelling style determining section 146A sets the travelling style to the constant speed travel. To cause the vehicle M to travel following the vehicle ahead, the travelling style determining section 146A sets the travelling style to the following travel. In a traffic jam or the like, the travelling style determining section 146A sets the travelling style to the slow following travel. The travelling style determining section 146A sets the travelling style to the deceleration travel when it is recognized by the outside recognizing section 142 that the vehicle in front of the vehicle M is decelerating or when an event that stops or parks the vehicle M is to be executed. When it is recognized by the outside recognizing section 142 that the vehicle M is entering a curve, the travelling style determining section 146A sets the travelling style to the curve travel. When an obstacle is recognized in front of the vehicle M by the outside recognizing section 142, the travelling style determining section 146A sets the travelling style to the obstacle avoiding travel. At the process of executing the lane changing event, takeover event, diverging event, merging event, handover event, or the like, the travelling style determining section 146A determines the travelling style in accordance with the respective events.

The trajectory candidate generating section 146B generates a trajectory candidate based on the travelling style determined by the travelling style determining section 146A. FIG. 7 is a diagram illustrating examples of the trajectory candidate generated by the trajectory candidate generating section 146B. FIG. 7 illustrates trajectory candidates generated when the vehicle M is scheduled to move from a lane L1 to a lane L2.

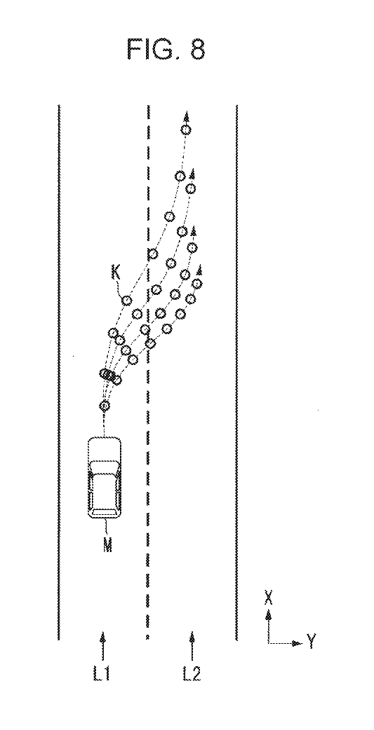

The trajectory candidate generating section 146B determines a trajectory (as illustrated in FIG. 7) as a group of target positions (trajectory points K) that the reference position (the center of gravity or the center of the rear wheel axis, for example) of the vehicle M is to reach at predetermined intervals in future. FIG. 8 is a diagram illustrating trajectory candidates generated by the trajectory candidate generating section 146B with the trajectory points K. The wider the intervals of the trajectory points K, the higher the speed of the vehicle M. The narrower the intervals of the trajectory points K, the lower the speed of the vehicle M. The trajectory candidate generating section 146B therefore gradually increases the intervals of the trajectory points K in order to accelerate the vehicle M and gradually reduces the intervals of the trajectory points K in order to decelerate the vehicle M.

Since each trajectory point K includes a speed component as described above, the trajectory candidate generating section 146B needs to give target speed to each trajectory point K. The target speed is determined in accordance with the travelling style determined by the travelling style determining section 146A.

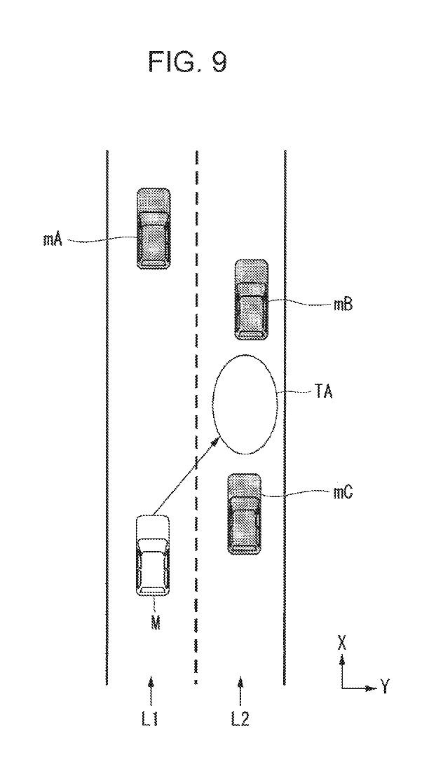

Herein, a description is given of a method of determining the target speed in the process of lane change (including diverging). The trajectory candidate generating section 146B first sets a lane change target position (or a marge target position). The lane change target position is set as a relative position to surrounding vehicles and determines which surrounding vehicles the vehicle M is to move between. The trajectory candidate generating section 146B determines the target speed at changing lanes based on the lane change target position in relation to three surrounding vehicles. FIG. 9 is a diagram illustrating the lane change target position TA. In FIG. 9, L1 indicates the lane where the vehicle M is traveling while L2 indicates the adjacent lane. The surrounding vehicle traveling just in front of the vehicle M is defined as a preceding vehicle mA. The surrounding vehicle traveling just in front of the lane change target position TA is defined as a front reference vehicle mB. The surrounding vehicle traveling just behind the lane change target position TA is defined as a rear reference vehicle mC. The vehicle M needs to accelerate or decelerate in order to move to the side of the lane change target position TA. In this process, it is necessary to prevent the vehicle M from reaching the preceding vehicle mA. The trajectory candidate generating section 146B therefore predicts the situation of the three surrounding vehicles in future and determines the target speed so that the vehicle M does not interfere with the surrounding vehicles.

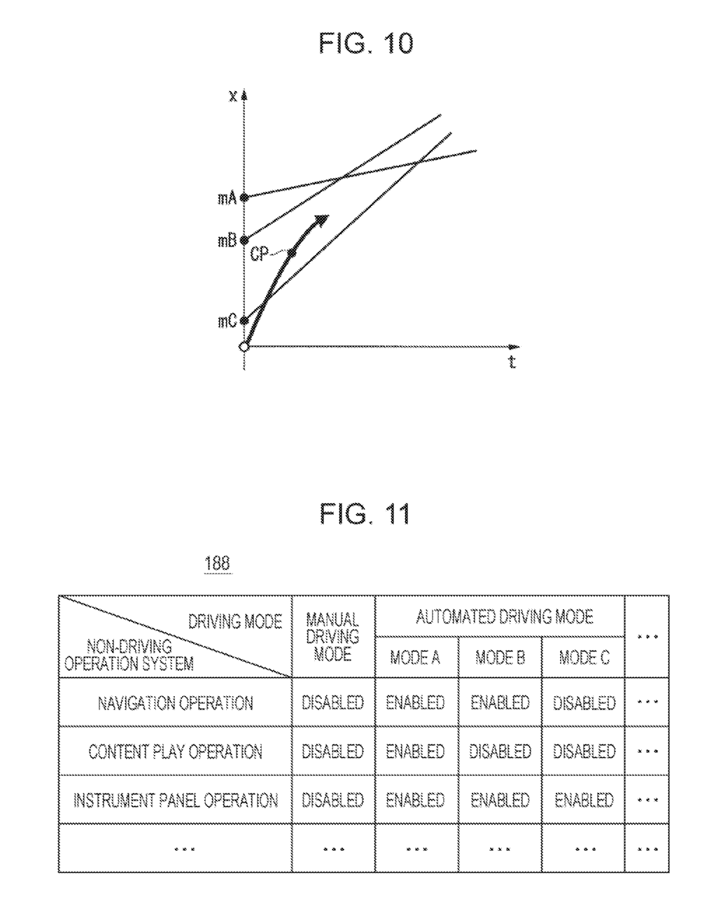

FIG. 10 is a diagram illustrating a speed generation model when the three surrounding vehicles are assumed to travel at constant speeds. In FIG. 10, the straight lines extending from mA, mB, and mC represent displacement in the travel direction when the three surrounding vehicles are assumed to travel at constant speeds. The vehicle M must be located between the front and rear reference vehicles mB and mC at a point CP where the vehicle M completes the lane change and must be located behind the preceding vehicle mA before the point CP. Under such restrictions, the trajectory candidate generating section 146B develops plural time-series patterns of the target speed to the end of the lane change. The trajectory candidate generating section 146B develops plural trajectory candidates as illustrated in FIG. 8 by applying a model, such as a spline curve, to the time-series patterns of the target speed. The motion patterns of the three surrounding vehicles may be predicted on the assumption that the three surrounding vehicles travel at constant speed as illustrated in FIG. 10 but also on the assumption that the three surrounding vehicles travel at constant acceleration or constant jerk.

The evaluation and selection section 146C evaluates the trajectory candidates generated by the trajectory candidate generating section 146B from two viewpoints of planning and safety, for example, and selects a trajectory to be outputted to the travel controller 160. From the viewpoint of planning, the evaluation and selection section 146C gives a high rating to a trajectory which is compatible with a plan already generated (an action plan, for example) and has a short length. For example, to move to the right lane, the evaluation and selection section 146C gives a lower rating to a trajectory of the vehicle M which involves moving to the left lane and then returning to the right lane. From the viewpoint of safety, the evaluation and selection section 146C gives a higher rating to such a trajectory that the vehicle is more distant from an object (the surrounding vehicles or the like) at each trajectory point and less changes in acceleration, deceleration, and steering angle.

The switch controller 150 mutually switches between the automated driving mode and manual driving mode based on a signal inputted from the automated driving switch 87. The switching controller 150 switches from the automated driving mode to the manual driving mode based on operations for the driving operation systems of the HMI 70 to make an instruction to accelerate, decelerate, or steer the vehicle M. When the amount of operation indicated by a signal inputted from the driving operation systems of the HMI 70 has continued to exceed the threshold value for a reference period of time or more, the switching controller 150 switches the driving mode from the automated driving mode to the manual driving mode (override). The switching controller 150 may restore the vehicle M to the automated driving mode when no operation for the driving operation systems of the HMI 70 is detected for a predetermined period of time after switching to the manual driving mode for override.

The travel controller 160 controls the travel driving force output device 200, steering device 210, and brake device 220 so that the vehicle M pass along the trajectory generated by the trajectory generating section 146B as scheduled.

The HMI controller 170 controls the HMI 70 depending on the type of the automated driving mode with reference to the mode-based restriction information 188 when notified by the automated driving controller 120 of information on the mode of automated driving.

FIG. 11 is a diagram illustrating an example of the mode-based restriction information 188. The mode-based restriction information 188 illustrated in FIG. 11 includes manual driving mode and automated driving mode as items of the driving mode. The automated driving mode includes Mode A, Mode B, and Mode C described above and the like. As items of non-driving operation, the mode-based restriction information 188 includes navigation operation which is operation for the navigation device 50, content play operation which is operation for the content player 85, and instrument panel operation which is operation for the display device 82. In the example of the mode-based restriction information 188 illustrated in FIG. 11, whether the vehicle occupant is allowed to operate each non-driving operation system is set based on the driving mode described above. However, the target interface devices are not limited to the aforementioned non-driving operation systems.

The HMI controller 170 refers to the mode-based restriction information 188 based on the mode information acquired from the automated driving controller 120 and determines enabled devices (the navigation device 50 and a part or all of the HMI 70) and disabled devices. Based on the determination result, the HMI controller 170 controls whether to accept the occupant's operation for the non-driving operation systems of the HMI 70 or the navigation device 50.

When the driving mode executed by the vehicle control system 100 is the manual driving mode, for example, the vehicle occupant operates the driving operation systems (the accelerator pedal 71, brake pedal 74, shifter 76, and steering wheel 78, for example) of the HMI 70. When the driving mode executed by the vehicle control system 100 is Mode B or Mode C of the automated driving mode, for example, the vehicle occupant is required to observe the surroundings of the vehicle M. In such a case, to prevent the vehicle occupant from being distracted by an action (operation for the HMI 70, for example) other than driving, the HMI controller 170 makes a control so that operations for some or all of the non-driving operation systems of the HMI 70 are disabled. In this process, in order to cause the vehicle occupant to observe the surroundings of the vehicle M, the HMI controller 170 may cause the display device 82 to display surrounding vehicles recognized around the vehicle M by the outside recognizing section 142 and the conditions of the surrounding vehicles in an image and allow the HMI 70 to accept confirmation operations depending on the situation of the traveling vehicle M.

When the driving mode is Mode A of the automated driving mode, the HMI controller 170 makes a control to relax the restrictions concerning the driver distraction and allow the non-driving operation systems of the HMI 70, which are not allowed to be operated in the other modes, to accept occupant's operations. For example, the HMI controller 170 causes the display device 82 to display video, causes the speaker 83 to output audio, and causes the content player 85 to play contents from a DVD or the like. The contents which are played by the content player 85 may include various types of contents concerning entertainment such as TV programs as well as contents stored in DVDs and the like. The “content play operation” illustrated in FIG. 11 may also include content operation concerning such entertainment.

### [Traffic Condition Estimation System]

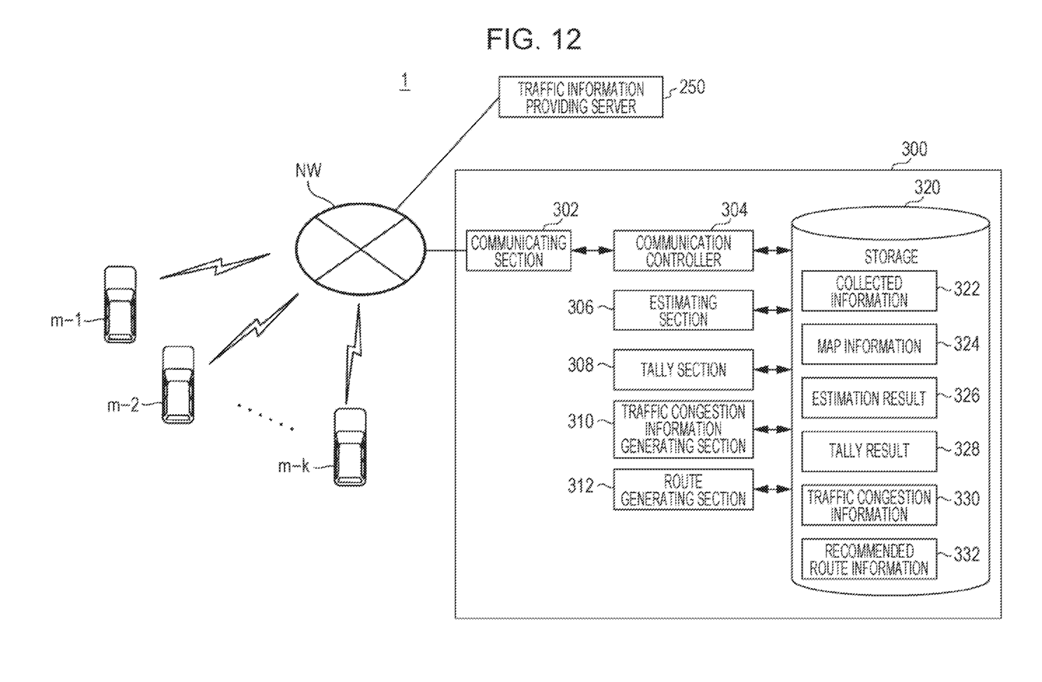

FIG. 12 is a diagram illustrating an example of the configuration of a traffic condition estimation system 1. The traffic condition estimation system 1 includes plural vehicles m-1 to m-k (k is an arbitrary natural number), a traffic information providing server 250, and a traffic condition estimation apparatus 300. The vehicles m-1 to m-k are referred to as vehicles m if not distinguished in particular. Some or all of the vehicles m are provided with some or all of the configurations of the vehicle control system 100 and the other devices illustrated in FIG. 2.

The vehicles m, traffic information providing server 250, and traffic condition estimation apparatus 300 communicate with each other using a network NW, for example. The network NW is a wide area network (WAN), a local area network (LAN), or the like, for example. The vehicles m are connected to the network NW using wireless communication via a mobile telephone network, a Wi-Fi network, or the like, for example. The traffic information providing server 250 and the traffic condition estimation apparatus 300 are connected to the network NW using wired communication such as the Internet or a dedicated line.

The traffic information providing server 250 manages traffic information including information transmitted from the vehicles m and information representing results of detection by sensors which are installed on road and are configured to detect vehicles traveling the road. The traffic information providing server 250 transmits the managed traffic information to the vehicles m or traffic condition estimation apparatus 300 in predetermined periods or transmits the traffic information in response to a request from the vehicles m or traffic condition estimation apparatus 300 to the source of the request. The traffic information is an example of “auxiliary information”.

The traffic condition estimation apparatus 300 includes a communicating section 302, a communication controller 304, an estimating section 306, a tally section 308, a traffic congestion information generating section 310, a route generating section 312, and a storage 320, for example. Some or all of the communicating section 302, communication controller 304, estimating section 306, tally section 308, traffic congestion information generating section 310, and route generating section 312 are implemented by the processor executing a program. Some or all thereof may be implemented by hardware such as an LSI or an ASIC or may be implemented by a combination of hardware and software. The storage 320 is implemented by a ROM, a RAM, a HDD, a flash memory, or the like. The communicating section 302 and communication controller 304 are an example of a collecting section in claims. The estimating section 306 or the estimating section 306 and tally section 308 is an example of an estimating section in claims. The storage 320 stores information such as collected information 322, map information 324, an estimation result 326, a tally result 328, traffic congestion information 330, and recommended route information 332.

The communicating section 302 communicates with vehicles m and traffic information providing server 250. The communication controller 304 uses the communicating section 302 to acquire information from the vehicles m and traffic information providing server 250. The communicating section 302 acquires position information representing the position of each vehicle m from the vehicle m and information about the destination set in the vehicle m or information about the set travel route. The information transmitted from each vehicle m is associated with the identification information of the vehicle m, for example. The communication controller 304 uses the controller 302 to transmit the information stored in the storage 320 to the vehicles m or traffic information providing server 250.

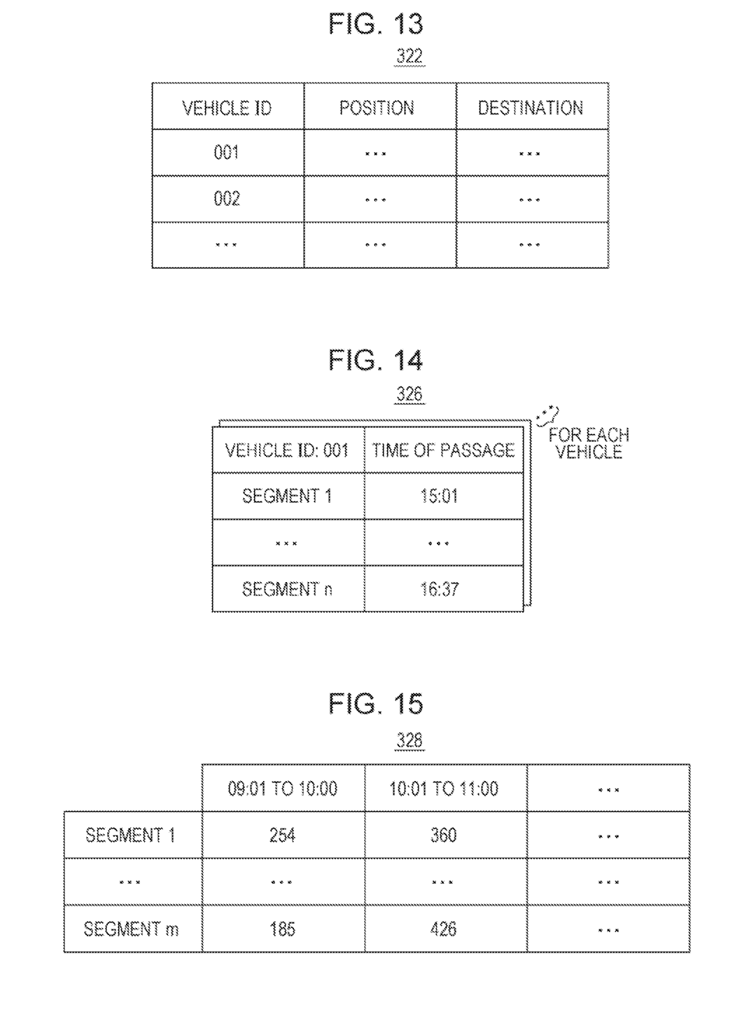

The collected information 322 is a list of the information collected from the vehicles m by the communicating section 302. FIG. 13 is a table illustrating an example of the collected information 322. The collected information 322 is information in which the identification information of each vehicle m is associated with the position information of the vehicle m and information of the destination set in the vehicle m. The position information of each vehicle m may be information including the longitude and latitude of the vehicle m or may be information representing a road link where the vehicle m is located.

The estimating section 306 estimates future traffic condition based on the information acquired by the communicating section 302. The estimating section 306 estimates the time at which the vehicles m having provided the information acquired by the communicating section 302 are going to pass each of at least one road segment. The estimating section 306 estimates the time at which the vehicles m are going to pass each road segment based on the route calculated by the route generating section 312, considering the information about average speed and the like acquired from the traffic information providing server 250.

The estimation result 326 is information representing the estimation result by the estimating section 306. The estimation result 326 includes the time of passage at which the vehicles m having provided the information are going to pass each of at least one segment. FIG. 14 is a table illustrating an example of the estimation result 326. The estimation result 326 is information in which the identification information of each vehicle m is associated with certain segments (1 to n in the table) and the time at which the vehicle m is estimated to pass the respective segments. Herein, n is an arbitrary natural number. Each segment may be a certain section of road or may be a section of a certain lane of road. When a certain section of road include plural lanes, for example, the estimating section 306 may estimate the number of vehicles m which are expected to pass each lane.

For example, the estimating section 306 instructs the route generating section 312 to calculate, based on the destination set for each vehicle m and the position information of the vehicle m, a route to the destination that the vehicle m is estimated to select. The route to the destination is calculated by a predetermined algorithm. The predetermined algorithm prioritizes the route that takes the shortest amount of time to the destination, for example. The route generating section 312 may calculate a route to the destination based on the traffic information acquired from the traffic information providing server 250 and other information. Alternatively, the route generating section 312 may calculate a route to the destination considering a later-described tally result 328, the traffic congestion information 330, or the like in addition to the traffic information.

The tally section 308 tallies the number of vehicles m which are estimated to pass each of at least one road segment during each time period based on the time of passage estimated by the estimating section 306.

The tally result 328 is the number of vehicles tallied by the tally section 308 and is a list of the number of vehicles estimated to pass during each time period in a monitoring area. The monitoring area is an area monitored by the traffic condition estimation apparatus 300. FIG. 15 is a table illustrating an example of the tally result 328. The tally result 328 is information in which each of the segments (1 to m) within the monitoring area is associated with the number of vehicles which are estimated to pass the segment during each time period. Herein, m is an arbitrary natural number. In the example illustrated in FIG. 15, totally 254 vehicles are estimated to pass segment 1 during the time period from 9:01 to 10:00, and totally 360 vehicles are estimated to pass segment 1 during the time period from 10:01 to 11:00.

The traffic congestion information generating section 310 generates information concerning the presence and the degree of traffic congestion based on the number of vehicles m tallied by the tally section 308 for each of at least one road segment.

The traffic congestion information 330 includes information representing the presence of traffic congestion or information representing the degree of traffic congestion. For example, the traffic congestion information 330 is information such as that the degree of traffic congestion in a certain segment is high during the time period from 9:01 to 10:00; the degree of traffic congestion in a certain segment is low during the time period from 10:01 to 11:00, and a certain segment is not congested.

The route generating section 312 generates recommended routes for some or all of the vehicles m based on the future traffic condition estimated by the estimating section 306 and map information 324. The map information 324 includes road information such as, road links, road nodes, and the number of lanes of each road, for example. The map information 324 may be a high-precision map including more detail information in addition to the road information.

The recommended route information 332 is information including recommended routes for the vehicles m. The recommended route information 332 includes road links, road nodes, lane information, information representing the names of roads included in the recommended route, for example.

### [Traffic Congestion Reducing Process]

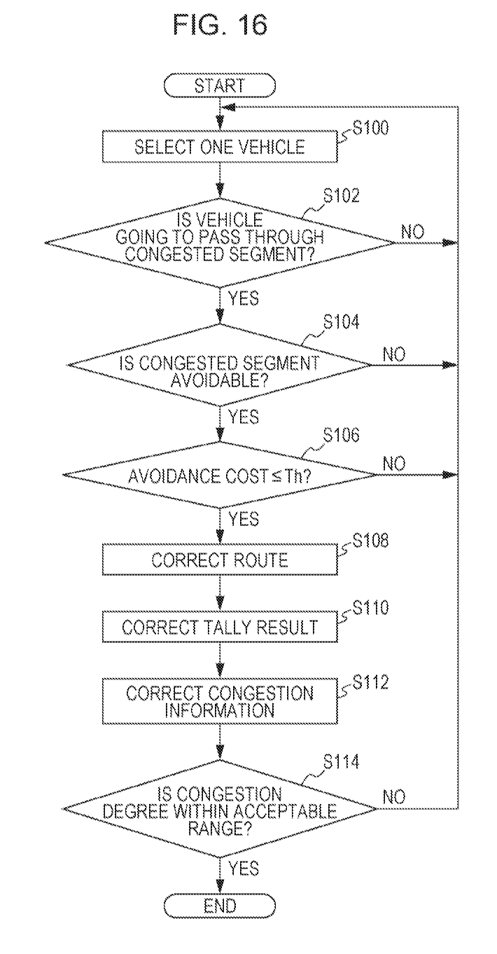

FIG. 16 is a flowchart illustrating the flow of the process executed by the traffic condition estimation apparatus 300. The process is executed at a predetermined period (at an interval of 10 minutes, for example), for example. The process is to reduce traffic congestion in the monitoring area.

The estimating section 306 selects one arbitrary vehicle m (step S100). Next, the estimating section 306 determines whether the selected vehicle m is expected to pass through a highly congested segment (step S102). Based on the route calculated from the destination set for the selected vehicle m and the traffic congestion information 330, the estimating section 306 determines whether the selected vehicle m is expected to pass the congested segment. When the route of the vehicle m is already calculated in the process of calculating the estimation result 326, the estimating section 306 may incorporate the same route.

When the selected vehicle m is expected to pass the congested segment, the estimating section 306 determines whether the vehicle m is able to avoid the congested segment (step S104). The estimating section 306 instructs the route generating section 312 to calculate a new route different from the already calculated route to the destination. When a new route is calculated, the estimating section 306 determines that the vehicle m is able to avoid the congested segment, for example. When there is no other route to the destination and a new route is not calculated, the estimating section 306 determines that the vehicle m cannot avoid the congested segment.

The estimating section 306 may determine whether the time at which the vehicle m enters the congested segment is able to be delayed. The time at which the vehicle m enters the congested segment is delayed by delaying the start time, reducing the travel speed of the vehicle, or the like. The estimating section 306 determines whether the time at which the vehicle m enters the congested segment is able to be delayed based on the target arrival time previously set by the vehicle occupant.

When the vehicle m is able to avoid the congested segment, the estimating section 306 then determines whether avoidance cost is more than a threshold Th (step S106). The avoidance cost includes vehicle's energy consumption, travel time, and the like. The avoidance cost also may be an index calculated based on a function reflecting the vehicle's energy consumption and/or travel time, for example.

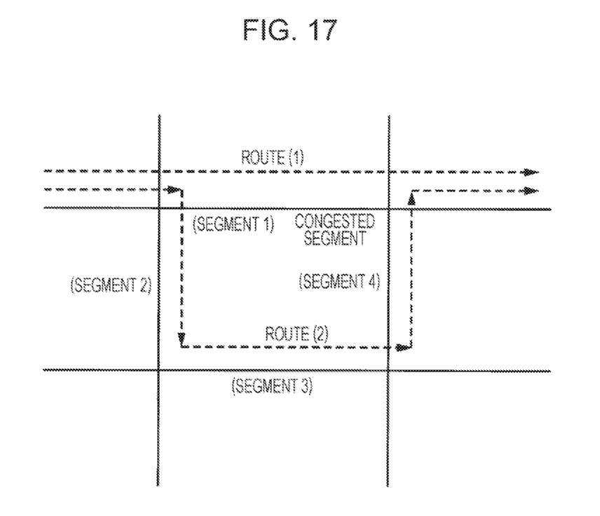

FIG. 17 is a diagram illustrating examples of the route calculated by the route generating section 312 under the instruction of the estimating section 306. In the illustrated example, route (1) is an already calculated route to the destination. Route (1) is the shortest to the destination but passes through the congested segment. Route (2) is a new route different from the already calculated route and is a detour that does not pass through the congested segment. The estimating section 306 determines that the avoidance cost is not more than threshold Th when the following conditions are satisfied, for example: Arrival time of the vehicle M at the destination via route (2) is estimated to be later than arrival time via route (1), within a predetermined time. Simultaneously, the energy consumption of the vehicle M via route (2) is estimated to equal to or lower than via route (1) by a predetermined amount.

When the avoidance cost exceeds the threshold Th, when the selected vehicle m is not estimated to pass through the congested segment, or when the selected vehicle m is not able to avoid the congested segment, the process returns to step S100 and selects another vehicle m different from the already selected vehicles.

When the avoidance cost does not exceed the threshold Th, the estimating section 306 corrects the route passing through the congested segment to a newly calculated route (a recommended route) (step S108). When the time at which the vehicle m enters the congested segment is delayed in step S104, the estimating section 306 corrects the time of passage at which the selected vehicle m is expected to pass through the congested segment when needed. The correcting the time of passage means that the estimating section 306 corrects or rewrites the estimation result 326. The information of the route newly calculated may be transmitted to the vehicle m selected in step S100.

Next, the tally section 308 corrects the tally result 328 based on the corrected estimation result 326 (step S110). The tally section 308 tallies the number of vehicles passing each segment during each time period, based on the corrected tally result 328.

Next, the traffic congestion information generating section 310 corrects the traffic congestion information 330 based on the corrected tally result 328 (step S112). Next, the estimating section 306 determines whether the degree of traffic congestion is within an acceptable range based on the corrected traffic congestion information 330 (step S114). When the degree of traffic congestion is not within the acceptable range, the process returns to the step S100. When the degree of traffic congestion is within the acceptable range, the process of the flowchart is terminated.

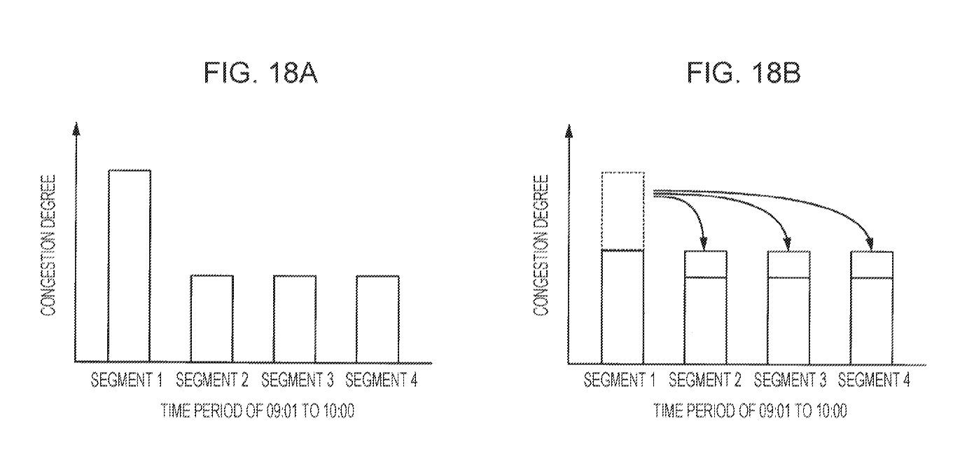

FIGS. 18A and 18B are diagrams illustrating the future degree of traffic congestion in the monitoring area which changes due to the process illustrated in FIG. 17. FIG. 18A illustrates the future degree of traffic congestion during a certain time period before the process is performed. FIG. 18B illustrates the future degree of traffic congestion during the certain period time after the process is performed. In the example illustrated in FIGS. 18A and 18B, the monitoring area includes segments 1 to 4. The vertical axis indicates the degree of traffic congestion. The four bars indicate degrees of traffic congestion in the segments 1 to 4.

The aforementioned process corrects the routes of some of the vehicles expected to pass through segment 1, so that the vehicles pass through other segments. This reduces the traffic congestion in segment 1.

As described above, the traffic condition estimation apparatus 300 estimates segments through which vehicles m are expected to pass in future and the time at which the vehicles m are expected to pass through each segment based on the collected information 322. The traffic condition estimation apparatus 300 estimates the future traffic condition including the number of vehicles and the degree of traffic congestion in each segment in future based on the estimation results. The traffic condition estimation apparatus 300 reduces traffic congestion in the monitoring area by properly distributing the segments through which the vehicles are expected to pass.

### [Recommended Route Providing Process]

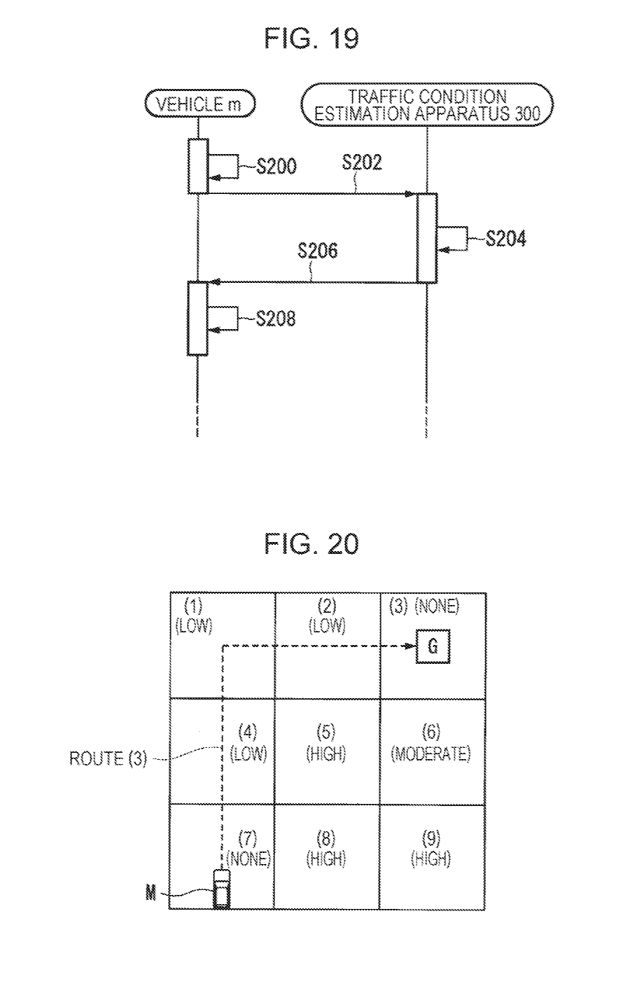

FIG. 19 is a flowchart illustrating a flow of the process executed between the vehicles m and traffic condition estimation apparatus 300.

First, when the destination of the vehicle m is set by the vehicle occupant of the vehicle m (step S200), the information on the set destination is transmitted to the traffic condition estimation apparatus 300 (step S202).

Next, the route generating section 312 of the traffic information estimation apparatus 300 calculates a recommended route based on the transmitted information on the destination and the traffic congestion information 330 (step S204) and transmits the information on the calculated recommended route to the vehicle m (step S206). The recommended route is a route that allows the vehicle m to avoid the congested segment calculated by the process of FIG. 16 and spends an avoidance cost not more than the threshold Th, for example. The vehicle m generates an automated driving plan based on the information about the recommended route (step S208). One routine of the process is thus terminated.

The recommended route calculated in the aforementioned step S204 is the shortest route that allows the vehicle m to avoid traffic congestion while arriving at the destination earliest, for example. FIG. 20 is a diagram illustrating an example of the shortest route calculated by the traffic condition estimation apparatus 300. In FIG. 20, 1 to 9 indicate segments, and “(LOW)”, “(MODERATE)”, and “(HIGH)” indicate the degree of traffic congestion. “(NONE)” indicate that the segment is not congested. In this case, the route generating section 312 calculates route (3) along which the vehicle m is expected to pass through the segments with a low degree of traffic congestion and arrive at the destination in the shortest time. As described above, the route generating section 312 calculates a route which allows the vehicle m to arrive at the destination earliest based on the future traffic condition estimated from the collected information 322.

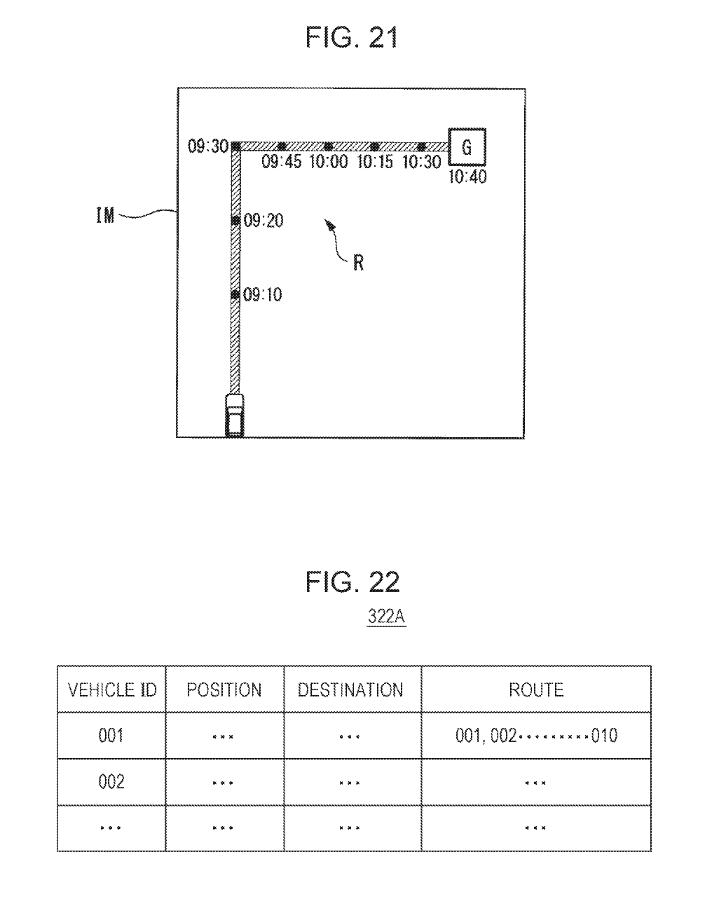

The route generating section 312 may generate information representing the segments through which each vehicle m is expected to pass and the time at which the vehicle m is expected to pass through each segment based on the estimated future traffic condition and transmit the generated information to the vehicle m. FIG. 21 is a diagram illustrating an example of an interface image IM displayed on the display device 82 of each vehicle m. As illustrated in FIG. 21, the display device 82 displays the vehicle m, destination G, recommended route R, and a region including information in which the times when the vehicle m are expected to pass through respective points on the recommended route R are associated with each other. The information is generated based on the future traffic condition. The vehicle occupant thereby recognizes the time at which the vehicle is expected to pass through each segment, which is calculated based on the future traffic condition.

When the vehicle occupant sets the destination as described above, the recommended route to the destination is calculated by the traffic condition estimation apparatus 300. The vehicle control system 100 generates an automated driving plan based on the recommended route and controls the vehicle M based on the generated plan. The traffic information estimation apparatus 300 thereby distributes the segments through which vehicles m are expected to pass. This reduces traffic congestion in the monitoring area while guiding the vehicle m to the destination so that the vehicle m avoid congested segments.

### [Modification 1]

The collected information in Modification 1 of embodiment includes information different from the collected information 322 in the aforementioned embodiment. Collected information 322A of Modification 1 includes the identification information and position information of the vehicles m and the information of the destination set in each vehicle m and further includes the route to the destination set in each vehicle m. FIG. 22 is a diagram illustrating an example of the collected information 322A of Modification 1. For example, the traffic information estimation apparatus 300 acquires information of road links where the vehicle m is expected to travel as the route to the destination.

In this case, the estimating section 306 does not need to estimate the route to the destination. This can reduce the processing load on the apparatus. The estimating section 306 is therefore capable of estimating the future traffic condition based on the acquired route with a high degree of accuracy.

### [Modification 2]

Modification 2 is different from the aforementioned embodiment in that the auxiliary information includes information acquired from the vehicles m. In Modification 2, collected information 322B is collected. The collected information 322B includes the identification information and position information of vehicles m and the information of the destination set in each vehicle m and further includes information concerning the behavior of the vehicle m traveling on the road (speed, time at which the vehicle m passes a certain point, and the like). For example, the collected information 322B includes the automated driving plan, the section where the vehicle m performs manual drive, the average speed during manual drive, and other information. The information concerning the behavior is another example of the auxiliary information. The automated driving plan includes the segments where the vehicle m is expected to perform automated drive, an action plan of automated drive, and the like. The average speed during manual drive may be acquired from the vehicle m or may be acquired from a device other than the vehicle m, for example. The traffic condition estimation apparatus 300 acquires the average vehicle speed in each segment through which the vehicle m is expected to pass, for example. Herein, the average vehicle speed is transmitted from the information providing server 250.

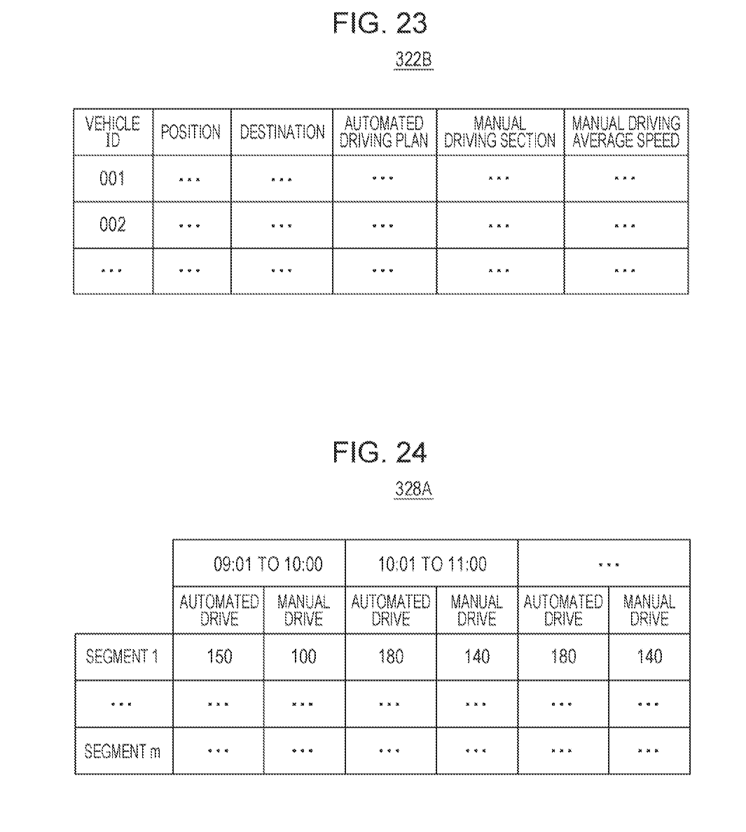

FIG. 23 is a diagram illustrating an example of the collected information 322B of Modification 2. The traffic condition estimation apparatus 300 acquires average speed of a vehicle m which performs automated drive (or which is not provided with a function of automated drive) or average speed on the road that the vehicle m is expected to travel. The average speed may be an average speed for each predetermined section of the road. For example, vehicles which perform automated drive to the destination transmit information concerning automated driving plans. Vehicles which switch between manual driving and automated drive to the destination transmit average speed in a segment that the vehicle is expected to perform manual drive and information concerning the automated driving plans for a segment where the vehicle is expected to perform automated drive.

The tally section 308 tallies the number of vehicles m which are expected to pass through each of at least one road segment during each time period for each automated driving mode based on the time at which the vehicles m are expected to pass through the segment by the estimating section 306. FIG. 24 is a diagram illustrating an example of the tally result 328A of the tally section 308 of Modification 2.

The traffic congestion information generating section 310 generates for each of at least one road segment, information concerning the presence or degree of traffic congestion based on the number of vehicles m tallied by the tally section 308 for each automated driving mode. For example, the traffic congestion information generating section 310 estimates that vehicles m in automated drive pass though each segment with a more efficient behavior than vehicles in manual drive. The traffic congestion information section 310 weights vehicles in manual drive more than vehicles in automated drive. The traffic congestion information generating section 310 estimates the degree of traffic congestion to be higher in segments where more vehicles m are in manual drive.

As described above, the traffic condition estimating apparatus 300 is capable of estimating the future traffic condition with a higher degree of accuracy by additionally considering the behavior of each vehicle m.

According to the aforementioned embodiment, the traffic condition estimation apparatus 300 includes the collecting section which communicates with at least one vehicle to collect the position of the vehicle and information on the destination set in the vehicle, and the estimating section which based on the information collected by the collecting section, estimates future traffic condition. The traffic condition estimation apparatus 300 is thereby capable of estimating the future traffic condition.

Hereinabove, the aspects of the present disclosure are described using the embodiment. However, the present disclosure is not limited to the embodiment, and various modifications and substitutions can be made without departing from the scope of the disclosure. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

We claim:

1. A traffic condition estimation apparatus comprising:
a collecting controller configured to communicate with at least one vehicle and collect information concerning a position of the at least one vehicle and a destination set in the at least one vehicle; and
an estimating controller configured to estimate future traffic condition by using the information collected by the collecting controller.

2. A traffic condition estimation apparatus comprising:
a collecting controller configured to communicate with at least one vehicle and collect information concerning a position of the at least one vehicle and a travel route set in the at least one vehicle; and
an estimating controller configured to estimate future traffic condition by using the information collected by the collecting controller.

3. The traffic condition estimation apparatus according to claim 1, wherein
the estimating controller estimates, for each of at least one road segment, time of passage at which each of the at least one vehicle which has provided the information collected by the collecting controller is expected to pass through the each of at least one road segment.

4. The traffic condition estimation apparatus according to claim 3, wherein the collecting controller collects auxiliary information used for the estimating controller to estimate the time of passage.

5. The traffic condition estimation apparatus according to claim 4, wherein
as the auxiliary information, the collecting controller collects average speed on road where the at least one vehicle which has provided the information collected by the collecting controller is expected to travel, by communicating with the at least one vehicle or a device other than the at least one vehicle.

6. The traffic condition estimation apparatus according to claim 4, wherein, from the at least one vehicle performing automated drive, the collecting controller collects information concerning a plan of the automated drive as the auxiliary information.

7. The traffic condition estimation apparatus according to claim 3, further comprising:
a tally controller configured to tally, for each of the at least one road segment, the number of vehicles which are expected to pass through the each of at least one road segment in each time period, by using the time of passage estimated by the estimating controller.

8. The traffic condition estimation apparatus according to claim 7, further comprising:
a traffic congestion information generating controller configured to generate information concerning the presence or degree of traffic congestion for each of the at least one road segment, by using the number of vehicles tallied by the tally controller.

9. The traffic condition estimation apparatus according to claim 1, further comprising:
a route generating controller configured to generate a recommended route for the at least one vehicle by using the future traffic condition estimated by the estimating controller.

10. The traffic condition estimation apparatus according to claim 2, wherein
the estimating controller estimates, for each of at least one road segment, time of passage at which each of the at least one vehicle which has provided the information collected by the collecting controller is expected to pass through the each of at least one road segment.

11. The traffic condition estimation apparatus according to claim 10, wherein the collecting controller collects auxiliary information used for the estimating controller to estimate the time of passage.

12. The traffic condition estimation apparatus according to claim 11, wherein
as the auxiliary information, the collecting controller collects average speed on road where the at least one vehicle which has provided the information collected by the collecting controller is expected to travel, by communicating with the at least one vehicle or a device other than the at least one vehicle.

13. The traffic condition estimation apparatus according to claim 11, wherein, from the at least one vehicle performing automated drive, the collecting controller collects information concerning a plan of the automated drive as the auxiliary information.

14. The traffic condition estimation apparatus according to claim 10, further comprising:
a tally controller configured to tally, for each of the at least one road segment, the number of vehicles which are expected to pass through the each of at least one road segment in each time period, by using the time of passage estimated by the estimating controller.

15. The traffic condition estimation apparatus according to claim 14, further comprising:
a traffic congestion information generating controller configured to generate traffic congestion information concerning the presence or degree of traffic congestion for each of the at least one road segment, by using the number of vehicles tallied by the tally controller.

16. The traffic condition estimation apparatus according to claim 15, further comprising:
a route generating controller configured to generate a recommended route for the at least one vehicle by using the traffic congestion information such that the at least one vehicle avoids a first road segment with traffic congestion.

17. A vehicle control system, comprising:
an automated driving controller configured to execute automated drive that automatically performs at least one of vehicle speed control and steering control, wherein
the automated driving controller determines a plan of the automated drive by reflecting the result of estimation by the traffic condition estimation apparatus according to claim 1.

18. A traffic condition estimating method, which is executed by an in-vehicle computer, the method comprising:
communicating with at least one vehicle to collect information concerning a position of the at least one vehicle and a destination set in the at least one vehicle; and
estimating future traffic condition by using the collected information.

19. A non-transitory computer readable medium storing a traffic condition estimating program causing an in-vehicle computer to execute processes to:
communicate with at least one vehicle to collect information concerning a position of the at least one vehicle and a destination set in the at least one vehicle; and
estimate future traffic condition by using the collected information.

20. The traffic condition estimation apparatus according to claim 16, wherein the tally controller updates the number of vehicles which are expected to pass through the first road segment by reflecting the recommended route, the traffic congestion information generating controller updates the traffic congestion information for the first road segment, by using the updated number of vehicles, and the estimating controller determines whether the degree of the traffic congestion in the first route segment is within an acceptable level, and if not, the route generating controller generates the recommended route for another vehicle such that the another vehicle avoids the first road segment.
